(19) United States
(12) Patent Application Publication
(10) Pub. No.: US 2024/0351669 A1
(43) Pub. Date: Oct. 24, 2024

(54) Smartphone Sailing Instrument with Bracket or Case and Visual Indication

(71) Applicant: WhitServe LLC, Stamford, CT (US)

(72) Inventors: Wesley W. Whitmyer, JR., Stamford, CT (US); Declan Wesley Whitmyer, Stamford, CT (US)

(21) Appl. No.: 18/644,995

(22) Filed: Apr. 24, 2024

Related U.S. Application Data
(60) Provisional application No. 63/497,893, filed on Apr. 24, 2023.

(51) Int. Cl. B63B 49/00; B63B 35/00; B63B 79/40; H02J 7/35; H04B 1/3877; H04M 1/04; H04W 4/14; H04W 4/40; H04W 4/80

(52) U.S. Cl. CPC B63B 49/00; B63B 79/40; H02J 7/35; H04B 1/3877; H04M 1/04; H04W 4/14; H04W 4/40; H04W 4/80; B63B 2035/009; H02J 2300/22

(57) ABSTRACT

An invention providing a racing instrument for a sailboat having a smartphone, an app executing on the smartphone for displaying at least speed over ground of the sailboat as sensed by the smartphone, a bracket for receiving at least an edge of the smartphone for mounting the smartphone to the sailboat, and an array of lamps formed in the bracket for visually indicating time to a race start. In another aspect, the invention includes a race starting device for a sailboat having an array of lamps, a mounting fixture for removably attaching the array of lamps to the sailboat, a battery for powering the array of lamps, a receiver for receiving a signal indicative of a race instruction, a processor for interpreting the race instruction signal, and a driver circuit for separately powering each of the lamps in the array of lamps to visually represent the race instruction to the sailors.

### TECHNICAL FIELD

An invention providing a racing instrument for a sailboat, using a smartphone, an app that displays information, and having a bracket for mounting with an array of lamps for visual indication of time to start race.

### BACKGROUND

Racing sailboats commonly have multiple sophisticated standalone sensors connected to one or more displays for presentation of sensor data to sailors to improve racing performance. Examples include GPS and other satellite navigation system sensors for position and speed and course over ground, wind sensors for direction and speed, compasses for (normally) magnetic heading, accelerometers for heel and pitch, thru-hull transducers for speed through water and depth, clocks for timing, Latitude/Longitude positions of racing marks, load sensors for measuring tension on various portions of the boat, and the like.

Data loggers have also been used to record data from the various racing sailboat sensors for analysis after the race in order to train sailors how to optimize velocity made good (VMG), e.g., in an upwind, downwind or other racing directions. For this purpose, the logged data can be presented in time-synchronized fashion with one or more factors presented together with speed (over ground or through the water) to analyze performance.

As smartphones have become more sophisticated, several apps have been written which essentially serve the data logging and transmission functions formally provided by laptop computers. These apps also provide some data analysis and visualization functions by superimposing racing tracks on maps and permitting time synchronization of instrument data as a function of speed or VMG. While use of smartphones in this way has begun to replace laptop computers which formerly received logged data from standalone sensors via USB cable, the boat sensors themselves have not significantly changed in that they are still provided as standalone products, albeit in some cases a single device may include several functions.

What is desired is to replace the standalone sensors on racing sailboats with the same smartphone used for data logging and transmission.

What is also desired is to use the same smartphone for indicating sensed data to racing sailors for example by screen or sound or light whether or not the smartphone is used as a racing sensor.

What is further desired is to use the smartphone for receiving race instructions and information from the organizing authority, race committee, umpires and/or other competitors and indicating it to racing sailors by screen or sound or light whether or not the smartphone is used as a racing sensor.

### SUMMARY

Accordingly, the invention provides a bracket or case for mounting a smartphone to a sailboat or sailor for use as a sailing instrument. The bracket or case optionally includes any of a battery, lights, GPS antenna, speaker, data and/or charging port, and solar panel. In this way all of the connectivity, charging, transmission, analysis and other smartphone functions are available for use by racing sailboat instrumentation.

In another aspect, the invention provides a visual indication bar that communicates race instructions and information received from the organizing authority, race committee, umpires, or other competitors even if no racing instruments are permitted by the event rules, class rules, organizing authority or Race Committee.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Reference is made to the following description of preferred embodiments in conjunction with the drawings.

FIG. 1 is a schematic diagram depicting a sailboat instrument system 100 that includes a smartphone 101 and a visual indicator 102.

FIG. 2 depicts the various elements of a case or bracket 200 including the visual indicator 102 (array of lamps 202).

FIG. 3 depicts a smartphone being inserted into the bracket or case.

FIG. 4 depicts the smartphone after insertion into the bracket or case.

FIG. 5 is a profile view of FIG. 4.

FIG. 6 depicts the sailing instrument 100 with a removable visor 604 and removable light diffusor 602 attached.

FIG. 7 depicts the profile view of FIG. 6.

FIG. 8 is a schematic diagram depicting components of a standalone visual indicator 800.

FIG. 9 is a schematic diagram depicting components of the sailing instrument system 100.

FIG. 10 is a schematic diagram depicting proposed light signals and corresponding signal flags related to race instructions for postponement and abandonment of a sailing race, as described in Racing Rules of Sailing (RRS 27.3, 32.1).

FIG. 11 is a schematic diagram depicting proposed light signals and corresponding signal flags related to race instructions for starting a sailing race, as described in Racing Rules of Sailing (RRS 26, 30).

FIG. 12 is a schematic diagram depicting proposed light signals and corresponding signal flags related to race instructions for adjustment of a sailing racecourse and other race instructions, as described in Racing Rules of Sailing (RRS 32, 33).

FIG. 13 is a schematic diagram depicting proposed light signals corresponding to numerals.

FIG. 14 is a schematic diagram depicting proposed light signals corresponding to the 5-minute starting sequence as detailed in Racing Rules of Sailing (RRS 26, 30, C3.1).

FIG. 15 depicts a smartphone case 1500 with a plurality of lamps 1502.

FIG. 16A-FIG. 16C depict a pair of smartphone cases 1600 that are connected together in landscape or in portrait mode.

FIG. 17A-FIG. 17C depict different configurations of the lamps 1502 on the smartphone case 1500.

FIG. 18A depicts a top view of a visual indicator/lightbar 1800 with a button for triggering a countdown sequence.

FIG. 18B-FIG. 18O depict the countdown sequence of the lightbar 1800.

FIG. 19A depicts a lamp configuration of a lightbar 1900.

FIG. 19B depicts a top view of the lightbar 1900.

FIG. 20 depicts multiple instances of the lightbar 1900 installed on a sailboat 2100.

FIG. 21 depicts the lightbar 1900 installed on a bicycle 2200.

FIG. 22 depicts the lightbar 1900 installed in an office 2300.

FIG. 23A-FIG. 23F depict lamp configurations of the lightbar 1900 that correspond to sailing flag signals.

FIG. 24A-FIG. 24C depict lamp configurations of the lightbar 1900 that correspond to bicycle directional indicators.

FIG. 25A-FIG. 25C depict lamp configurations of the lightbar 1900 that correspond to different types of message notifications.

FIG. 26 depicts a lamp configuration of the lightbar 1900 that corresponds to multiple simultaneous message notifications.

FIG. 27 depicts a lamp configuration of the lightbar 1900 that corresponds to multiple simultaneous message notifications.

FIG. 28A-FIG. 28C depict lamp configurations of the lightbar 1900 that correspond to different times of day.

FIG. 29 depicts a smartphone settings interface for configuring a smartphone to display notifications using the lightbar 1900.

### DETAILED DESCRIPTION

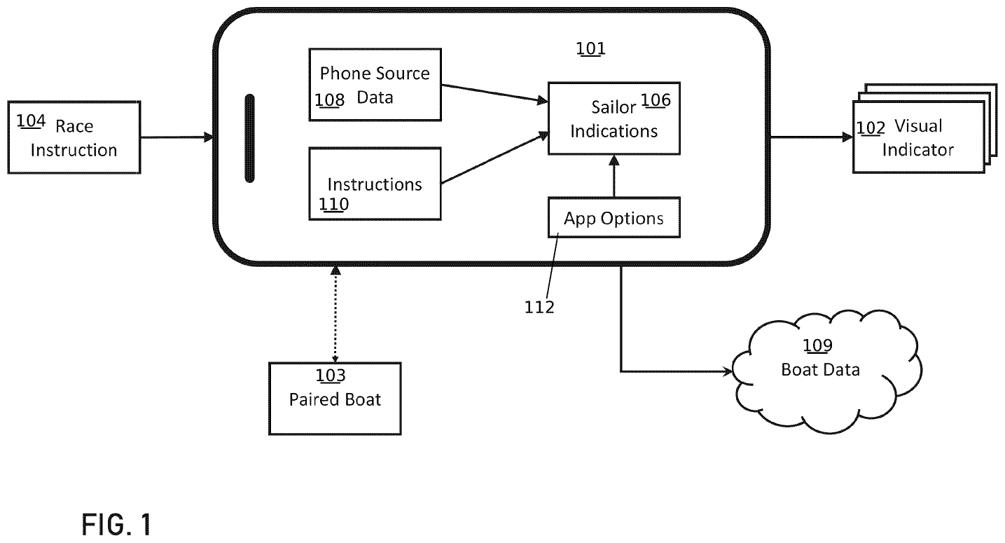

FIG. 1 is a schematic diagram depicting a sailboat instrument system 100 that includes a smartphone 101 and a visual indicator 102. The smartphone 101 is paired to a boat 103, on which the smartphone is mounted or carried as described below. According to operation of the system 100, the smartphone 101 executes an instance of a sailing instrument app. The smartphone instance of the app receives a race instruction 104 (e.g., from a race committee instance of the app, wirelessly, over-the-air). The smartphone instance of the app displays sailor indicators 106 based on phone source data 108, boat data 109, and instructions 110. App options 112 can be used to control which of or how the sailor indicators are displayed. Example sailor indicators/boat data include VMG, CMG, speed over ground, trim, heel, time to start, elapsed time, distance to mark, yard tension, etc. The smartphone instance of the app may control the visual indicator 102 according to one or more of the sailor indicators 106.

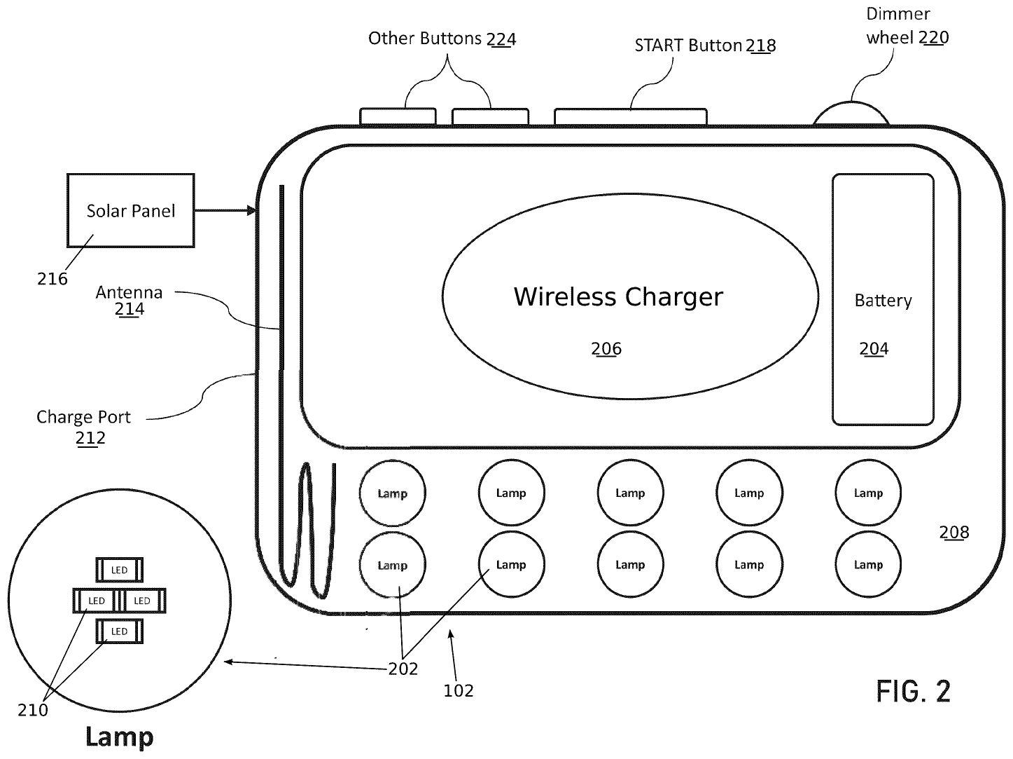

FIG. 2 depicts the various elements of a case or bracket 200 including the visual indicator 102 (array of lamps 202). According to aspects of the disclosure, the case 200 includes a battery 204 and may include a wireless charger 206, which are housed in a body 208. The body 208 also houses the lamps 202. Each of the lamps includes a plurality of LEDs 210. Optionally, the case 200 also includes a charge port 212 for connecting external power to charge the smartphone 101 via the wireless charger 206 and/or to charge the battery 204. The case 200 also may include an antenna 214 (which may be, for example, a satellite position antenna). The case 200 also may include a solar panel 216, which may charge the battery 204 and/or the smartphone 101. The case 200 also may include a start button 218, which may interact with the smartphone 101 to start or stop a race timer in the smartphone instance of the sailing instrument app. The case 200 also may include a dimmer wheel 220, which may control brightness of the lamps 202. The case 200 also may include other buttons 224, which may serve a variety of purposes in controlling the smartphone 101 and/or the lamps 202.

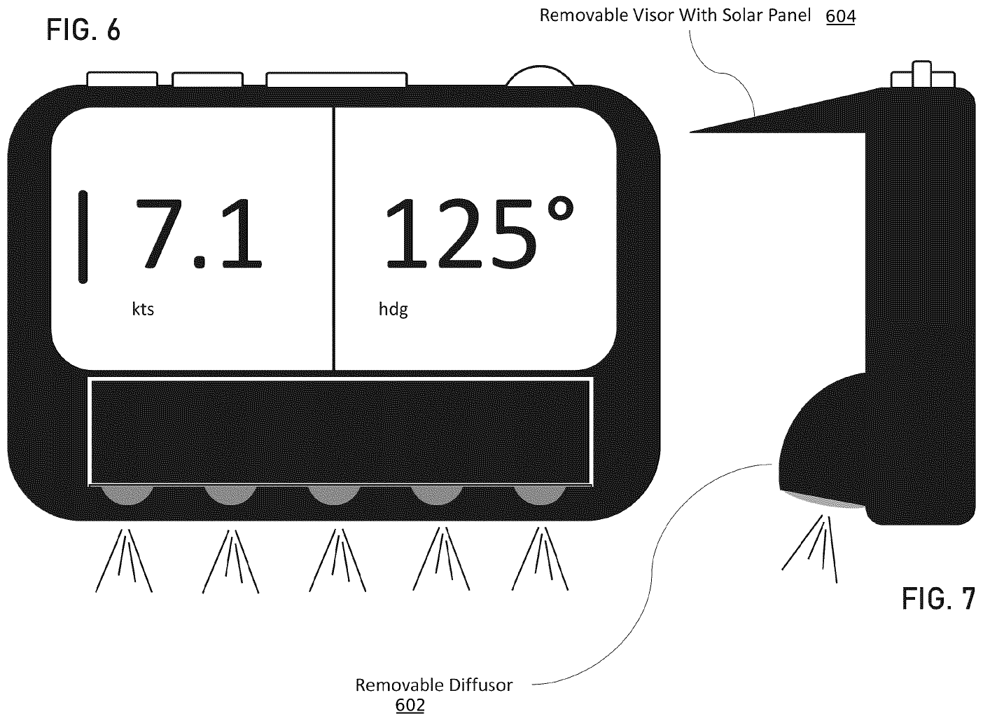

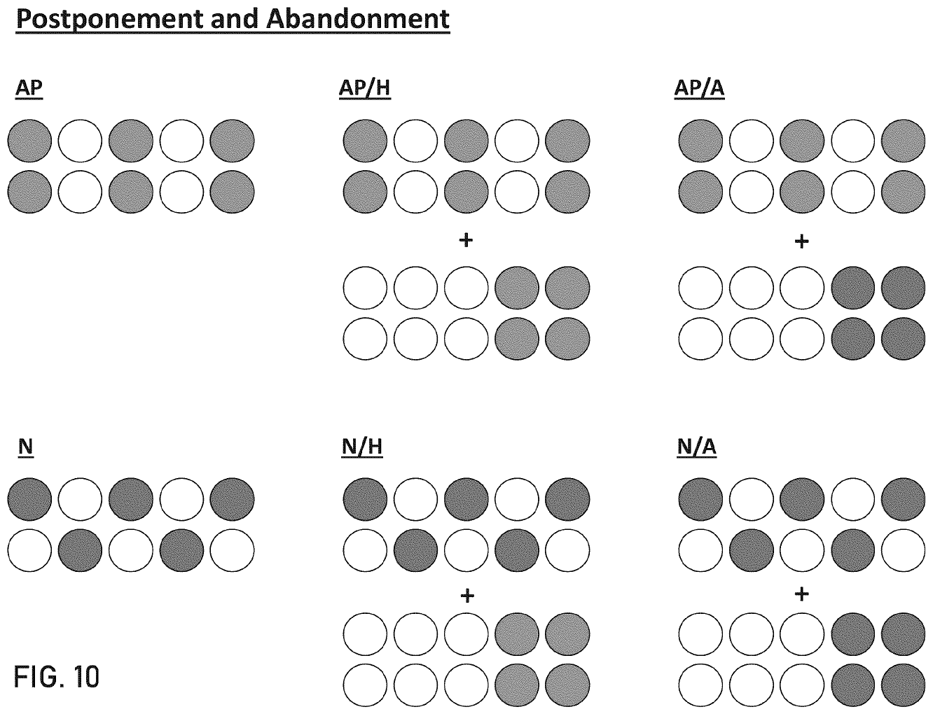

Each lamp 202 shown schematically in the later Figures as a dot is comprised of three or more independent but adjacent light emitting diodes 210, each of which can be driven at different amplitudes such that the visible light generated by each is blended to form a color of choice for visual indication to the sailor. In addition, the exemplary ten lamp dots shown schematically in FIGS. 10-14 can all be located behind a single lens or diffuser 602 (as shown in FIGS. 6 and 7). The dimmer knob or button or wheel 220 can be provided on the bracket or case 200 to adjust lamp brightness for ambient lighting conditions. Similarly, a visor 604 (as shown in FIG. 6) can be provided to make either the lamps or the smartphone screen easier to read in bright light conditions.

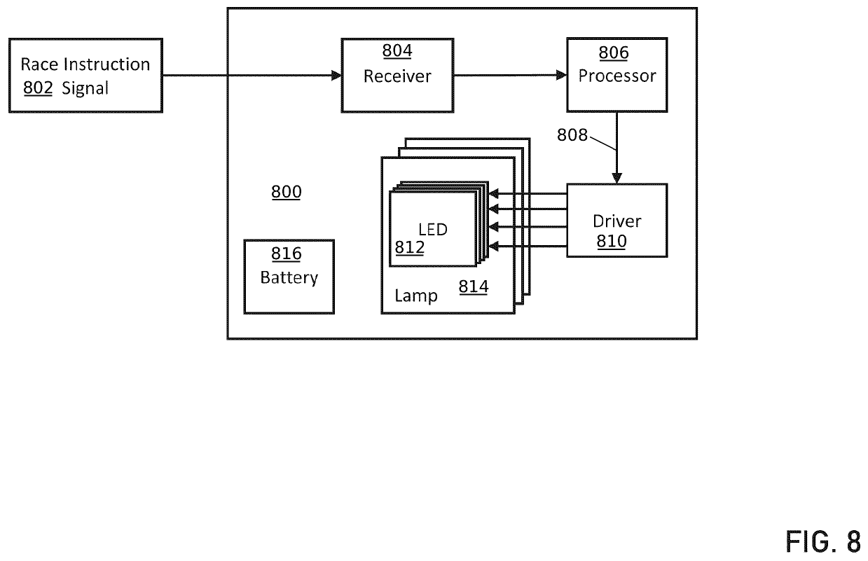

The bracket or case 200 or standalone visual indication bar 800 (as shown schematically in FIG. 8) can mount for example to a mast or other part of a sailboat, or to the wrist or other part of a sailor with hook and loop fasteners, or with bands that wrap around the mast or wrist of a sailor, or with a slug that fits in the sail groove of the mast, or directly to a sailor's life vest.

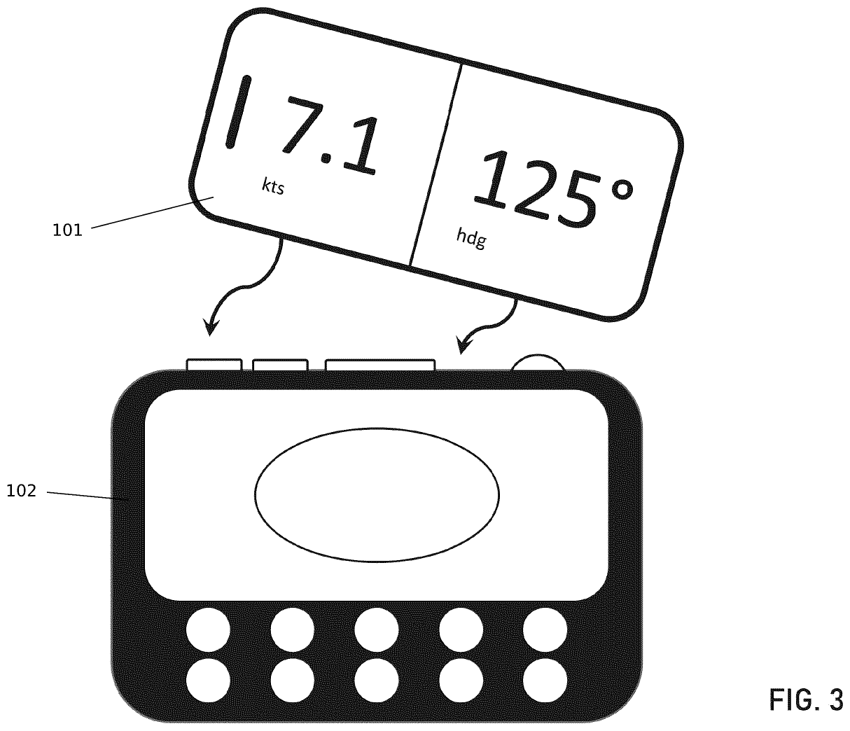

The bracket or case 200 can be injection molded or 3D printed or formed by another method and receives at least one edge of the smartphone 101 therein, as shown in FIG. 3. In portrait mode, the bracket or case normally receives at least the bottom edge, and in landscape mode the bracket or case would normally receive at least the left or right edge of the smartphone. In either option, the interface between the smartphone edge and the bracket or case serves to align the smartphone wireless charging feature with the wireless charger 206 if provided.

The bracket or case or visual indication bar can also include on a surface thereof or as an accessory, a solar panel 216 for trickle charging either the bracket/case/bar auxiliary battery 204 or the smartphone directly for example in the event the bracket/case is not provided with a battery. The accessory solar panel could be provided as mounted to the sailboat or sailor or sailor's life vest. Similarly, the auxiliary battery can be built into the sailor's life vest where it could also serve a safety function by flashing indicating lamps in a capsize or MOB situation identified by sensors in the smartphone or otherwise.

FIG. 3 depicts a smartphone 101 being inserted into the bracket or case 200.

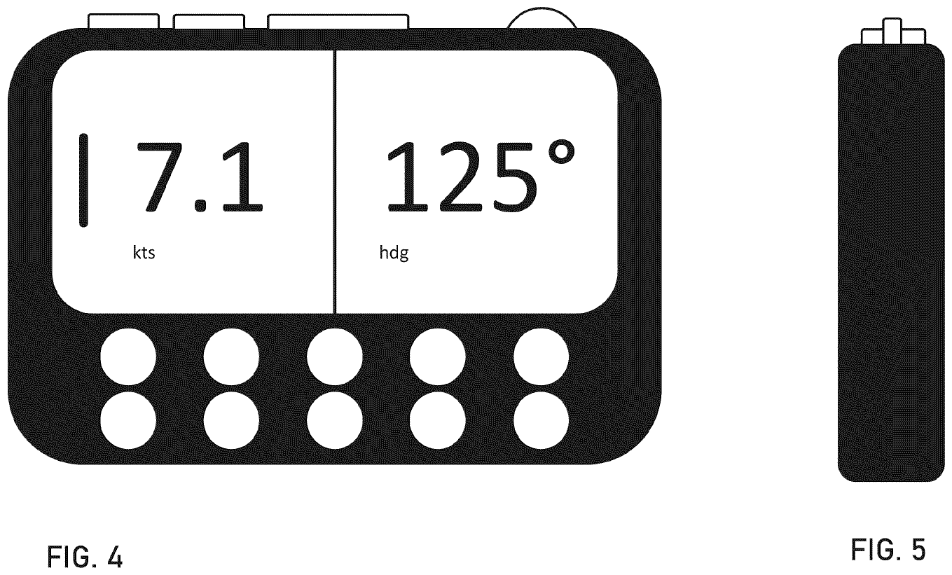

FIG. 4 depicts the smartphone 101 after insertion into the bracket or case 200.

FIG. 5 is a profile view of FIG. 4.

Once a smartphone has been placed into a bracket or case according to the invention, an instance of the sailing instrument app on the smartphone displays data sensed by the smartphone itself. The app preferably also optimizes the display mode and silences notifications and the like. This is what converts the smartphone from a mere data logger and transmission device on a sailboat into a racing instrument for the sailboat. While this may seem like a trivial use of the smartphone, all competitors in the field of racing sailboat instruments are designing new standalone sensor packs for use as sailboat racing instruments, focusing almost entirely on speed and accuracy of the GPS signal and readability of the display in direct sunlight. These are the two most cited reasons why a smartphone can't be used as a sailboat racing instrument.

What competitors and consumers don't understand is that every device receives the same GPS or other satellite navigation signal, every device uses similar GPS or other satellite navigation processing chips and electronics. Another important aspect of this invention is that any shortcomings of screen visibility in direct sunlight of a smartphone on a racing sailboat are easily overcome by accessory lamps as described in detail below. An array or lamps, each formed from an array of LEDs are low power, easy to see, easy to repeat around the boat, can be used to replicate flag, starting and other Race Committee and Umpire signals more efficiently than the flag and sound system and at a lower cost than standalone sailing instrument displays.

FIG. 6 depicts the sailing instrument 100 with a removable visor 604 and removable light diffusor 602 attached.

FIG. 7 depicts the profile view of FIG. 6.

The visor or other lamp diffuser or lens or screen magnifier can optionally be attached by small magnets to the bracket, and the upper surface of any bracket can conveniently include an integrated solar panel for charging the bracket battery.

The data most commonly used by racing sailors is speed and direction. The GPS sensor built into smartphones can readily provide GPS speed and direction, or speed and course over ground of the sailboat. And the magnetic compass feature built into smartphones can display heading of the sailboat. An app built for the smartphone can access this data for display and offer options for improving visibility for example based upon time of day, accessibility settings built into the smartphone. Such an app can also be used to drive auxiliary visual indicators such as LED lamp arrays to provide coded messages simultaneously to multiple sailors on the same racing sailboat, via brackets, cases, life vests or other wearables which include auxiliary lamps that may be provided as a strip array wherein each lamp is itself formed from an array of LEDs.

FIG. 8 is a schematic diagram depicting components of a standalone visual indicator 800. The visual indicator 800 receives a race instruction signal 802 at a receiver 804. The receiver passes the race instruction signal to a processor 806, which converts the signal to a light pattern 808 and sends the light pattern to a lamp driver 810. The lamp driver 810 energizes LEDs 812 in lamps 814 to display the light pattern sent from the processor. A battery 816 powers the visual indicator 800.

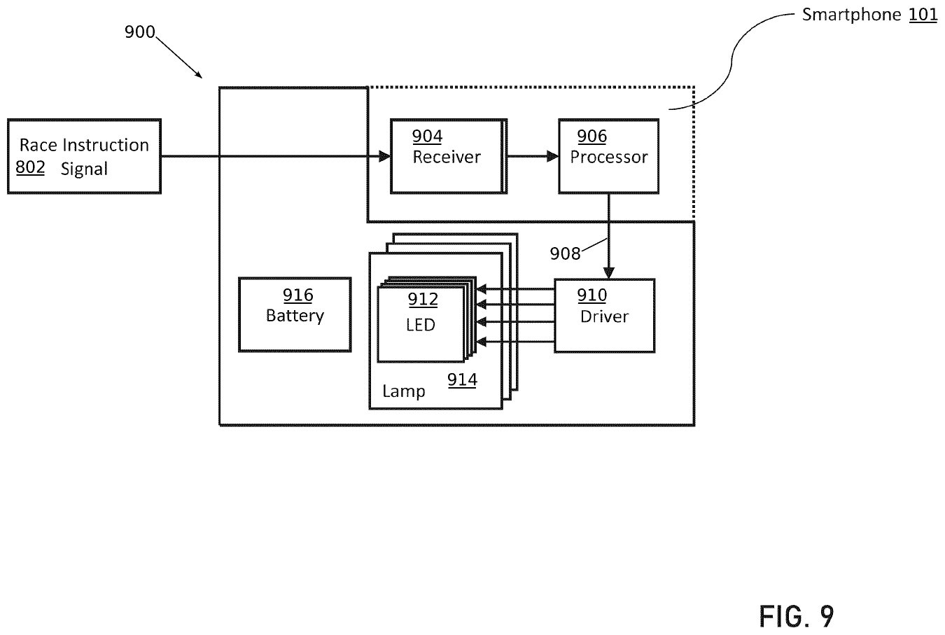

FIG. 9 is a schematic diagram depicting components of the instrument system 100. The smartphone 101 receives a race instruction signal 802 at a receiver 904. The processor 906 of the smartphone converts the race instruction signal to a light pattern 908 and sends the light pattern to a lamp driver 910. The lamp driver 910 energizes LEDs 912 in lamps 914 to display the light pattern sent from the processor. A battery 916 powers the lamp driver and the LEDs. Optionally, the battery 916 also provides power to recharge the smartphone 101.

Another data which may be generated by the smartphone for display via screen, visual lamp bar or other visual indication to sailors is elapsed time. Elapsed time both from initiation of a race starting sequence, and or elapsed time from the actual start of the race. In this way the proper race starting signals and time may be visually indicated to a racing sailor on each participating sailboat, and sailboat data uploaded to the cloud can be time synced to other boats.

Smartphones also generally include accelerometers and/or gyros the output of which can be interpreted as heel, pitch, heave, yaw, sway, or surge of a sailboat. These data, the most common of which is heel and pitch, can also be displayed on the phone screen at the option of a sailor.

The bracket or case or visual indication bar preferably also includes a plurality of lamps each of which can be illuminated in a variety of colors by an associated array of multicolor LEDs. The plurality of lamps may be provided for example in two or more ranks, which may be rows or columns, of, for example, five indicators. By using an odd number of lamps, each row can indicate a trend for the piece of data being visually indicated as there is a center lamp. By placing a plurality of lamps in a matrix, the lamps can be illuminated in different colors to, for example, replicate signal flags commonly used to instruct sailboats during races.

Alternatively, individual ranks or rows of lamps could indicate a different piece of data, or they could both indicate the same piece of data. In case they indicate different pieces of data it is suggested that one row might indicate time to start while the other one or more rows might indicate status of the start. By “status” is meant, distance to the starting line, time to the starting line, the starting system being employed by the Race Committee, e.g., P flag, I flag, Z flag, U flag, or Black flag, or the post-start status of a boat such as OCS, or if there is a general recall.

Informational lamps of this type could be mounted directly to the boat for signaling information from the Race Committee, Umpires, and the like even when the smartphone is not being used as a sailing instrument. In addition, LED lamp strips worn by sailors or integrated for example into their life vest could perform the same function. Multiple LED lamp rows or strips could be connected to a single phone e.g., via Bluetooth, or each sailor could receive their own Race Committee signals via their own smartphone to organize their own coded lamp message delivery.

FIG. 10 is a schematic diagram depicting proposed light signals to be implemented by a driver 910 or 810 of the instrument system 100 or visual indicator 800 in response to corresponding signals sent by a race committee for postponement or abandonment of a sailing race.

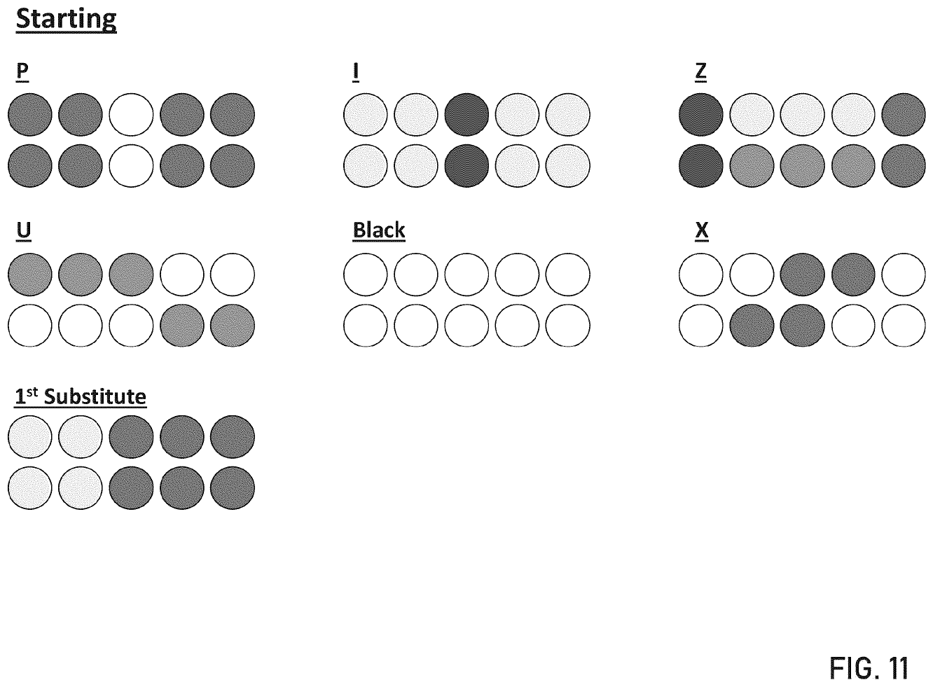

FIG. 11 is a schematic diagram depicting proposed light signals to be implemented by a driver 910 or 810 of the instrument system 100 or visual indicator 800 in response to corresponding signals sent by a race committee for starting a sailing race.

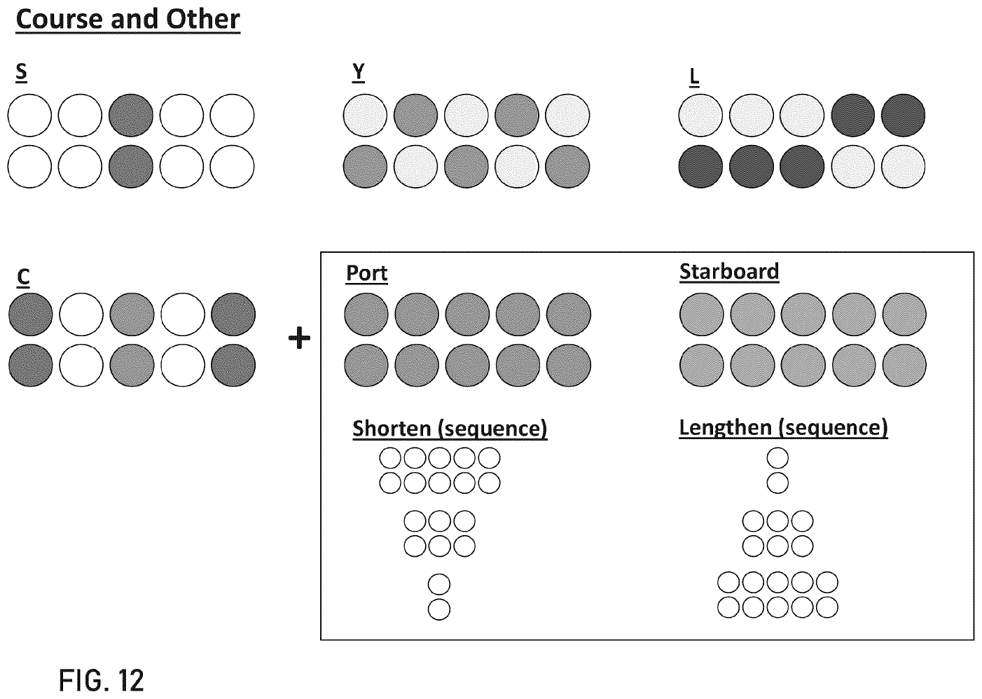

FIG. 12 is a schematic diagram depicting proposed light signals to be implemented by a driver 910 or 810 of the instrument system 100 or visual indicator 800 in response to corresponding signals sent by a race committee for adjustment of a sailing racecourse and other race instructions.

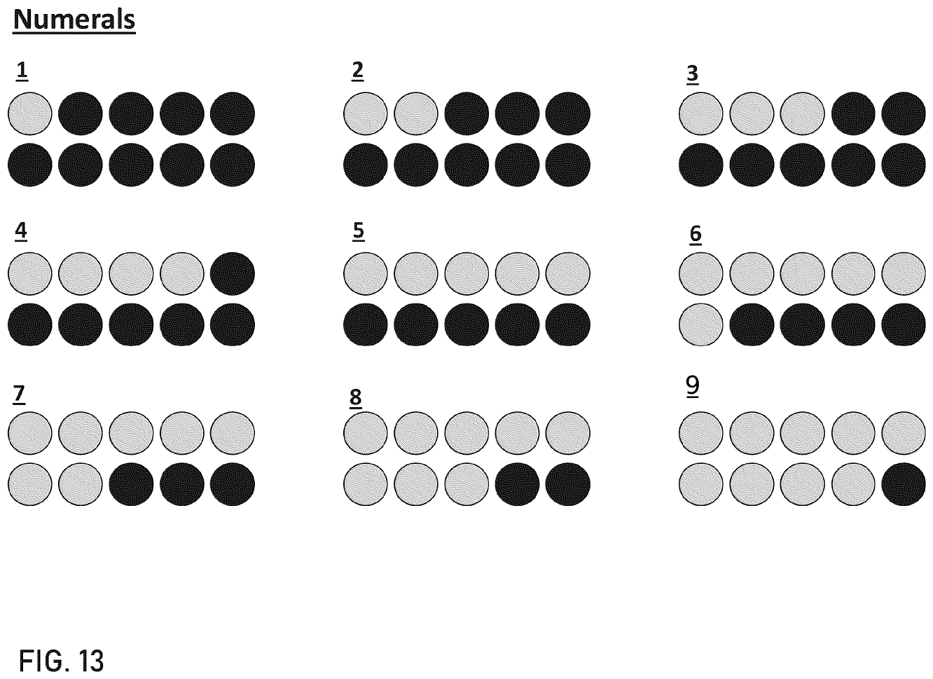

FIG. 13 is a schematic diagram depicting proposed light signals to be implemented by a driver 910 or 810 in response to signals corresponding to numerals.

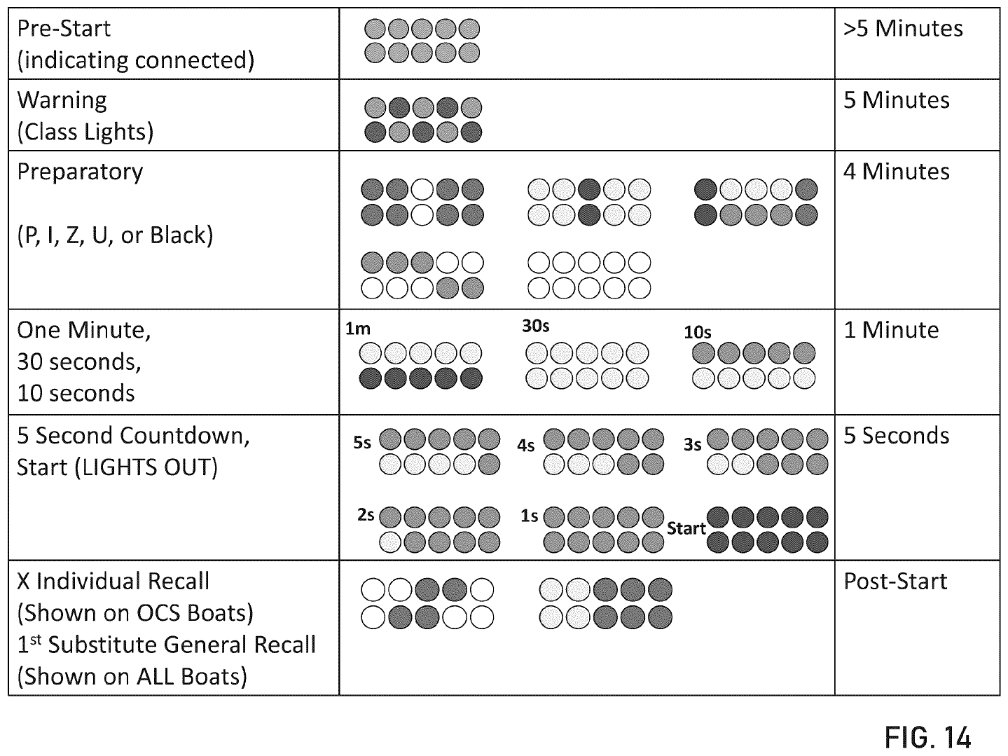

FIG. 14 is a schematic diagram depicting proposed light signals corresponding to the 5-minute starting sequence as detailed in Racing Rules of Sailing Rule 26.

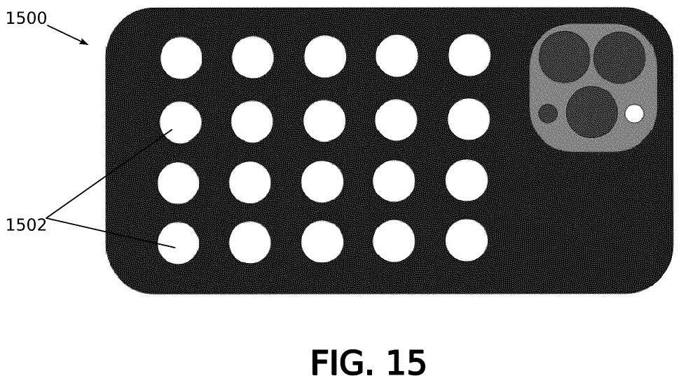

FIG. 15 depicts a smartphone case 1500 with a plurality of lamps 1502.

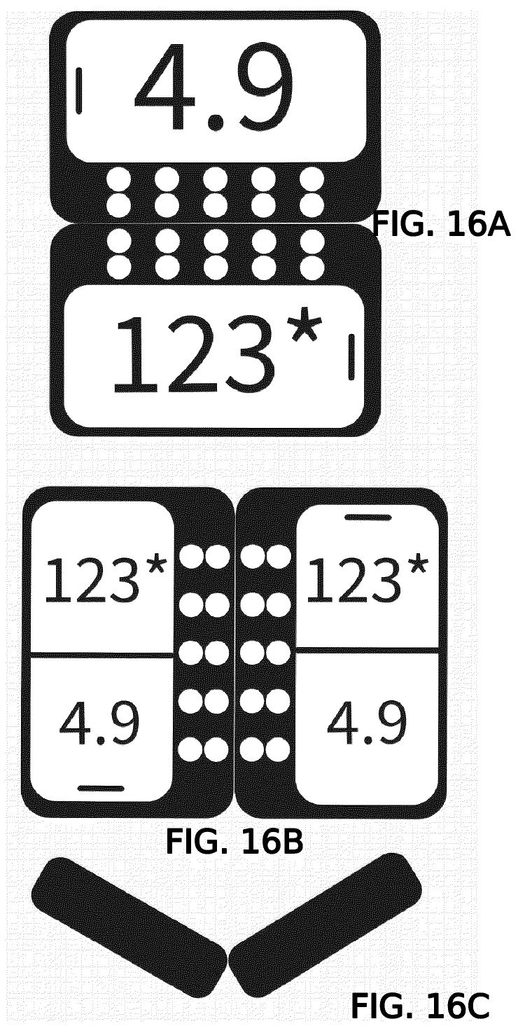

FIG. 16A-FIG. 16C depict a pair of smartphone cases 1600 that are connected together in landscape or in portrait mode.

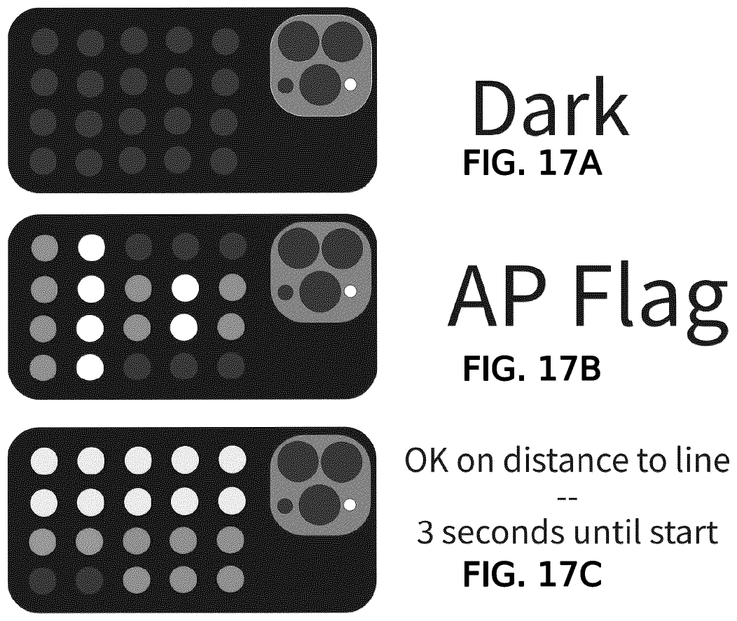

FIG. 17A-FIG. 17C depict different configurations of lamps on a smartphone case.

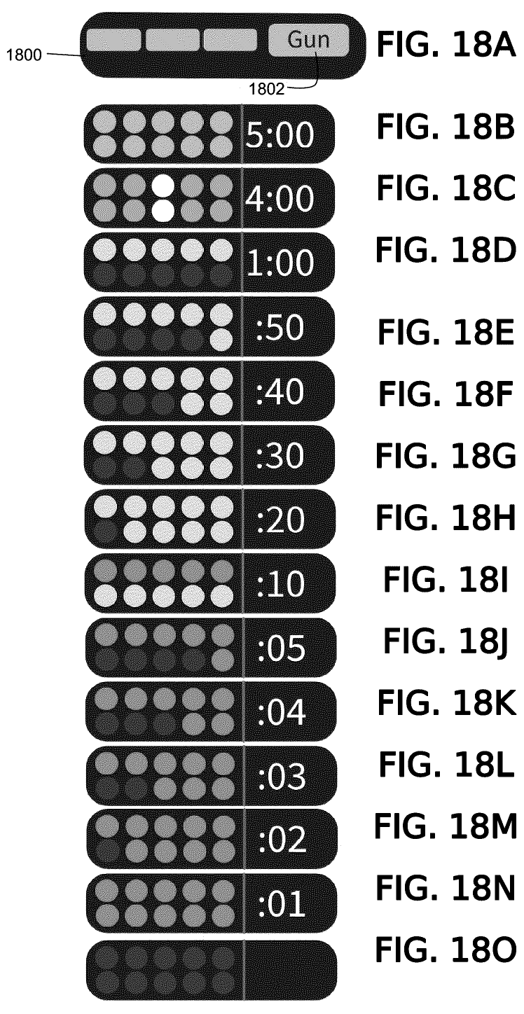

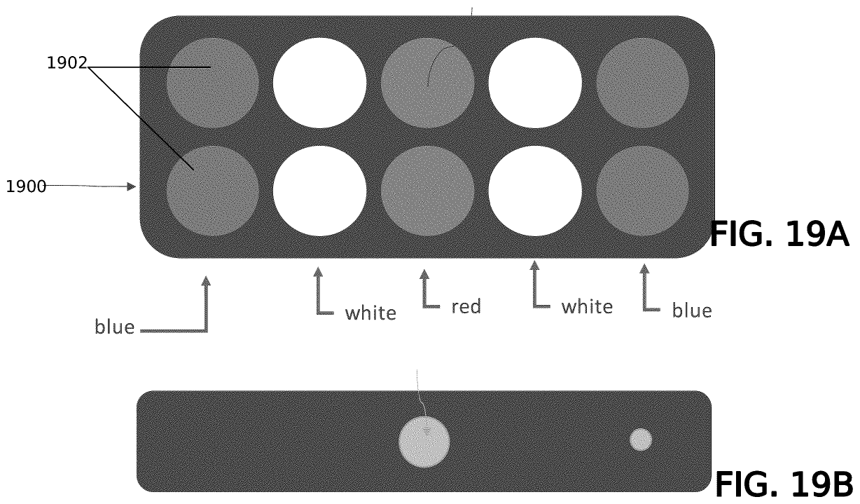

FIG. 18A depicts a top view of a visual indicator/lightbar 1800 with a button 1802 for triggering a countdown sequence.

FIG. 18B-FIG. 18O depict the countdown sequence of the lightbar 1800.

FIG. 19A depicts a configuration of lamps 1902 on a lightbar 1900.

FIG. 19B depicts a top view of the lightbar 1900.

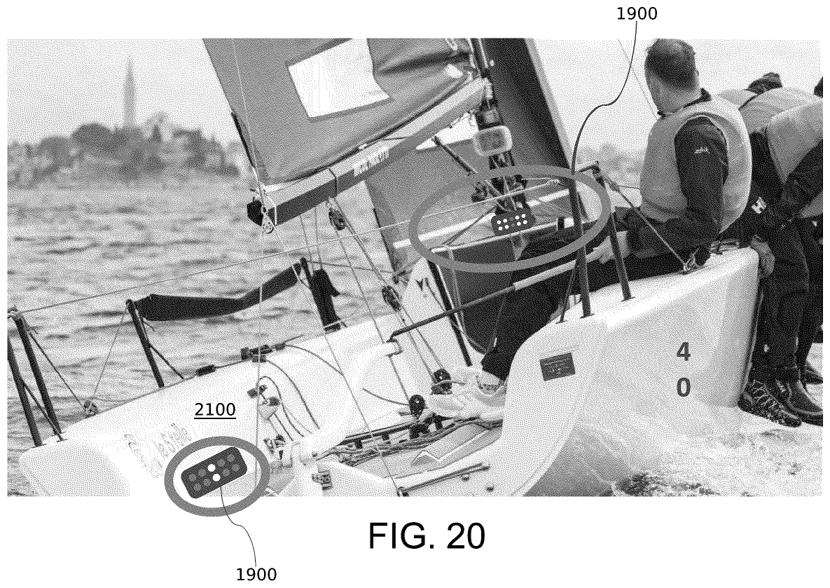

FIG. 20 depicts multiple instances of the lightbar 1900 installed on a sailboat 2100.

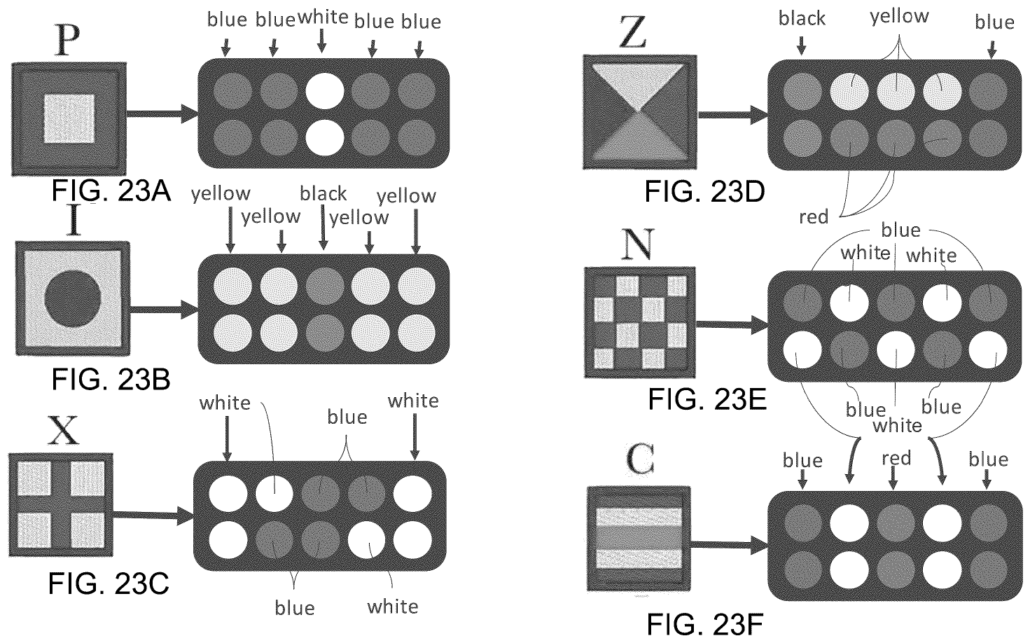

FIG. 23A-FIG. 23F depict lamp configurations of the lightbar 1900 that correspond to sailing flag signals.

Note too that after the race starts for any given racing sailboat and the lamp signals all go LIGHTS OUT™, individual boats could use the smartphone app to establish their own system of signaling to synchronize racing maneuvers. For example, most racing sailboats use a two or three step countdown before a tack or gybe or set or douse because coordination of these maneuvers increase the overall VMG of the racing sailboat and have a significant impact on performance. Currently this coordination is mainly carried out by yelling from one end of the sailboat to the other. Verbal signaling of this type is highly inefficient and often difficult in the windy, wavy conditions common on the racecourse.

Each signal flag utilized by the Race Committee, not only for starting system, but also for things like course change “C”, shortened course “S”, Abandonment “N”, Postponement “AP”, Individual recall “X”, General Recall “First Substitute”, Life Jackets Required “Y”, Come Within Hail “L” can be also represented by one or more rows of lamps presented in different color combinations which match the flag colors. The invention proposes lamp representations for the common signal flags using only two rows of five lamps, but it will be appreciated if other systems could be used. And it is also proposed that a light system of this type be adopted for use by the Race Committee, Umpires, and the like to rapidly communicate its decisions to all competitors in an instant and unambiguous way, as opposed to current flag and sound communication.

Another visual indication generated by the system for communication to racing sailors is the moment any particular sailboat finishes, which for example may advantageously be indicated on the finishing boat by randomly flashing the lamps in different colors to simulate confetti. Another option to indicate finish to a racing sailboat is a black and white checkered flag which could be indicated by illuminating half the lamps in the matrix white in a checkboard pattern.

The timing row or strip of lamps can borrow from Appendix U “Audible-Signal Racing System” of the Racing Rules of Sailing. The Audible System is well known to racing sailors but suffers the disadvantage that the sound generally emanates from only one end of the starting line which means sailors at the other end of the starting line (which can be a significant fraction of a mile away) are unable to accurately predict the time until the start because sound travels so much more slowly than light. Instead of long and short bursts of sound, the invention proposes long and short bursts of light from lamps mounted either on the smartphone bracket or case, or on the sailboat itself in the case of the visual indication bar, or indeed on the one or more individual racing sailors.

Auto racing has developed a light-based starting system which works very well and is proposed for use to start sailboat races using the invention. Instead of counting down, the system counts up for the last five seconds by illuminating consecutive lamps until all 5 are illuminated at 1 second intervals from 5 to 1 second before the start. The race start is indicated when all five lamps turn off.

An additional significant advantage to racing sailors of using the light signaling system of the invention is that sailing teams can develop their own signals for communicating timing of maneuvers such as tack, gibes, spinnaker sets and take-downs etc. on boats, where yelling was literally the only other option for attempting synchronicity necessary for success.

It will be understood to one of ordinary skill, that the lamp signaling aspect of the invention can be used on a sailboat with a smartphone even if the smartphone is not mounted in a bracket or case according to another aspect of invention. In such a system according to the invention, the visual indication bar itself can illuminate according to informational signals received from the Race Committee, Umpires, etc., whether or not the visual indication bar is connected to any smartphone on the sailboat. It will be understood that in such an embodiment the visual indication bar itself must have the ability to receive and decode signals from the Race Committee etc. in order to illuminate appropriate ones of the LEDs in the bar in an appropriate way to indicate the message to be delivered to the sailors.

It will also be understood that the Race Committee can signal each competitor's smartphone e.g., by SMS which can be interpreted by the smartphone and indicated via screen, or sound, or LED lamp bar on the bracket or case, or independent of the bracket or case.

Another feature that might advantageously be incorporated into a smartphone bracket or case according to the invention is an improved GPS antenna. While the signal available to all competitive GPS sailboat instrument systems is the same (it emanates from the sky) and also while GPS processing circuitry utilized by most if not all competitive GPS sailboat instrument systems is also the same, performance differences are really a function of signal strength which is directly related to antenna design.

The form factor of the smartphone bracket or case or life vest according to the invention can accommodate a significant upgrade in antenna size and gain, providing measurable improvements in signal strength and accuracy.

In addition to false claims about GPS accuracy of things like 1 cm which as discussed above not only is not possible but if it was possible would in fact be the same for all devices, competitors also falsely claim refresh rates that are not possible and boldly cite these falsehoods as reasons to prefer their sailboat racing instruments. For example, a 25 Hz refresh rate is not possible with any commercially available GPS analysis chip, including the chip used by competitors. Further, no human can reliably process data at 25 Hz for any extended period of time. What happens in fact is that the racing instrument data display refresh rate is always significantly lower than 25 Hz, so the information can be processed for action by the sailor.

Instead of buying sailboat instruments for false claims of accuracy, racing sailors should buy instruments which improve data indication and reduce cost.

In addition to using a smartphone sailing instrument according to the invention for racing, it can also be used for training. To improve performance, sailors will frequently test speed by sailing in the same direction, normally upwind, with a small gap between them with and with the leeward boat slightly ahead such that both boats are on the same upwind rung. The sailors then observe each other, and the slower boat makes changes to try and increase her speed to match the faster boat. This is an inexact science because the faster boat is also constantly making small changes to its direction, sail trim, etc. and the two boats are never exactly sailing in the same wind or waves but it's a proven technique.

To aid such training, the app could provide a split screen mode which displays both the speed and direction sensed by the smartphone for the boat it is on, and the speed and direction sensed by the smartphone for the lined-up boat it is speed testing with. This training mode could be implemented by a direct connection between the smartphones on each boat or it could be implemented by a transmission from the cloud which may or may not be permitted by the Race Committee. The permission aspect could allow for training races and even automatic sharing of data between any pairs of closest sailboats with approximately the same compass heading. In this manner, once one of the two paired boat tacks or gybes, data sharing stops because it is no longer meaningful and the smartphones on both boats look for another boat to share data with.

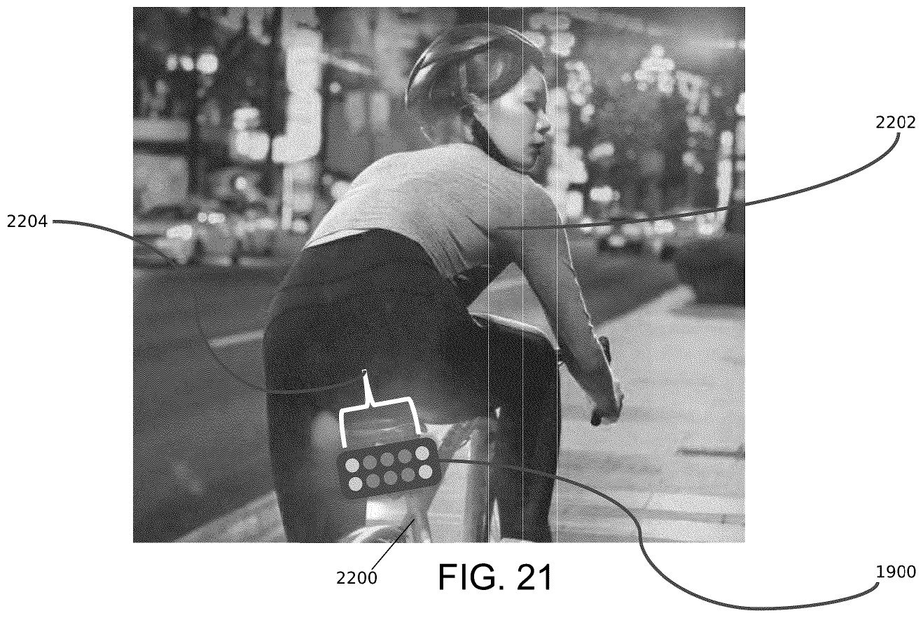

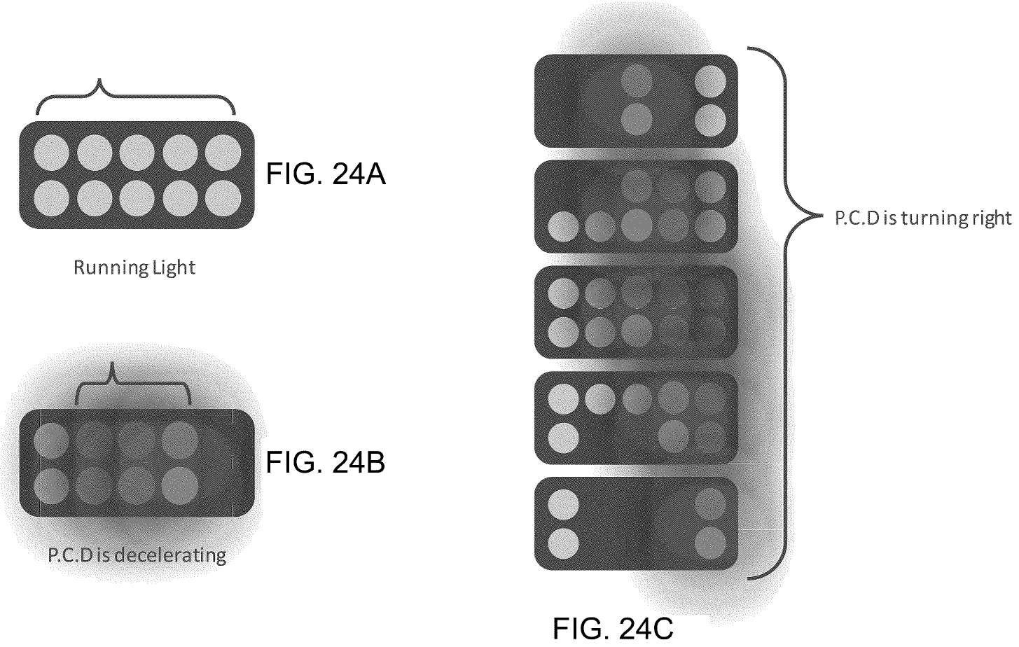

Other applications exist for the lightbar 1900. For example, FIG. 21 depicts the lightbar 1900 installed on a bicycle 2200. A bicycle rider 2202 can control the lightbar 1900, for example, by shifting her weight on the bicycle saddle 2204 so as to lean the bicycle into a turn or as to brace herself for slowing or stopping the bicycle. The rider's shifting weight may be detected by one or more strain gages (not shown) that can be connected wirelessly or by wires to an analog/digital converter circuit or similar input circuitry (not shown) of the lightbar 1900. FIG. 24A-FIG. 24C depict lamp configurations of the lightbar 1900 that correspond to bicycle directional indicators/displacements of bicycle rider weight.

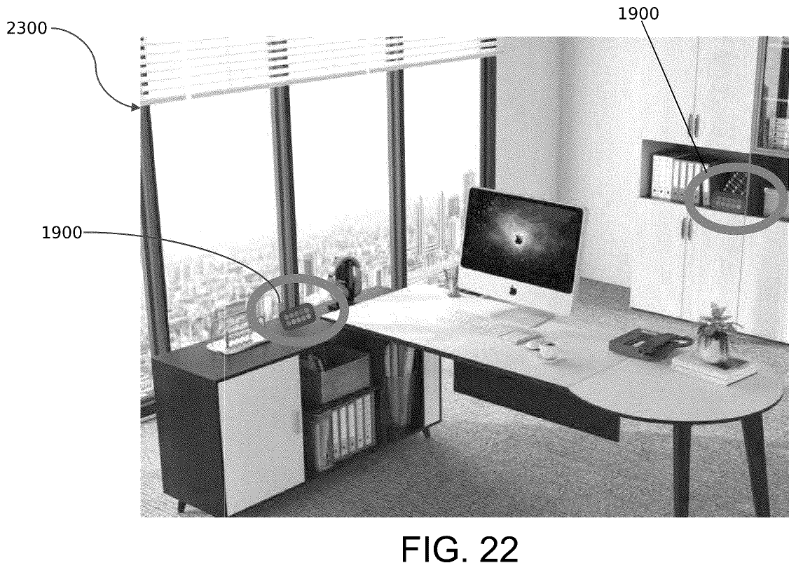

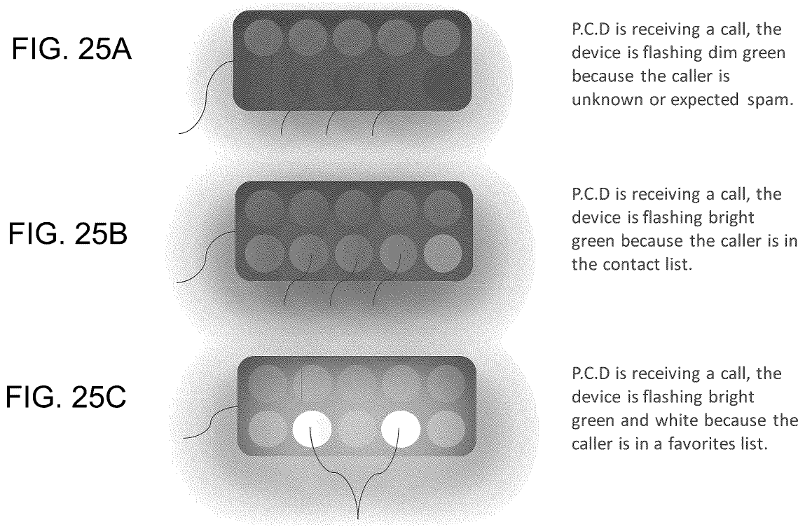

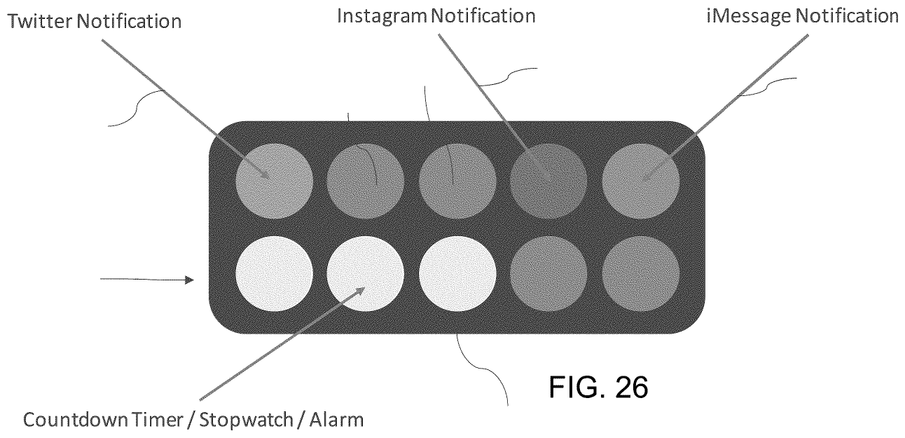

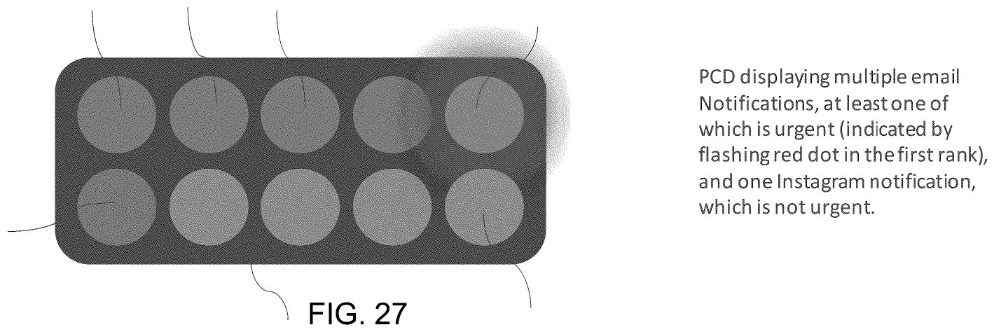

As another potential application, FIG. 22 depicts the lightbar 1900 installed in an office 2300. FIG. 25A-FIG. 25C depict lamp configurations of the lightbar 1900 that correspond to different types of software application (e.g., message) or system notifications. FIG. 26 depicts a lamp configuration of the lightbar 1900 that corresponds to multiple simultaneous message notifications. FIG. 27 depicts a lamp configuration of the lightbar 1900 that corresponds to multiple simultaneous message notifications.

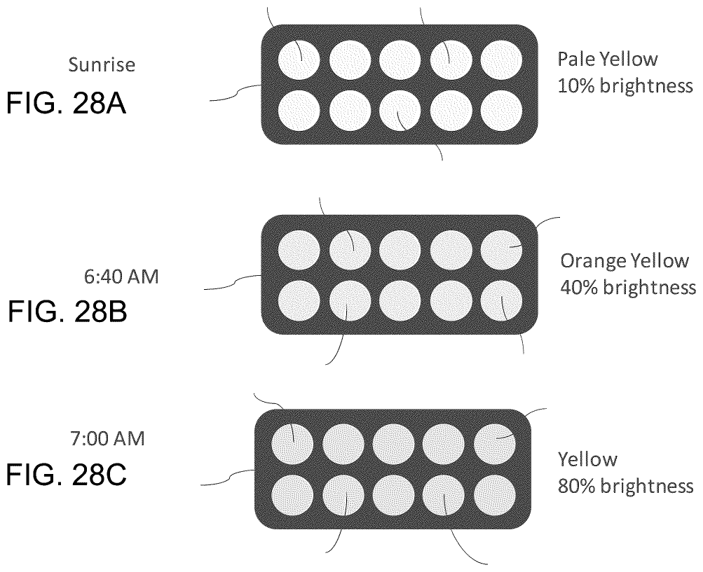

FIG. 28A-FIG. 28C depict lamp configurations of the lightbar 1900 that correspond to different times of day.

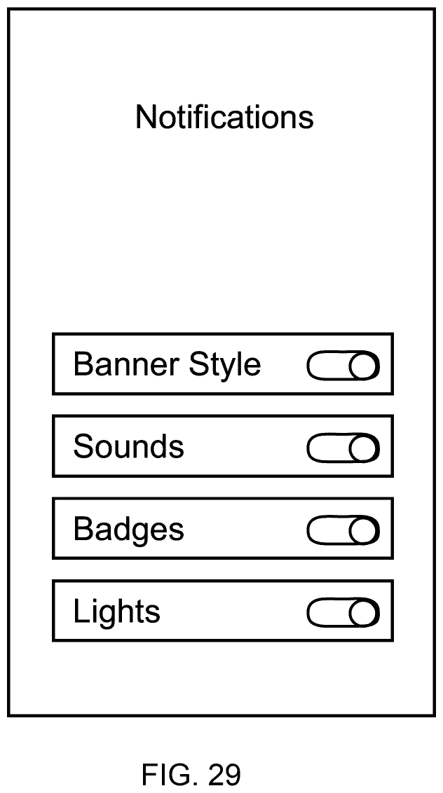

FIG. 29 depicts a smartphone settings interface for configuring a smartphone to display application or system notifications using the lightbar 1900.

1. A racing instrument for a sailboat comprising:
a smartphone;
an app executing on the smartphone for displaying at least speed over ground of the sailboat as sensed by said smartphone;
a bracket for receiving at least an edge of said smartphone for mounting said smartphone to the sailboat;
an array of lamps formed in said bracket for visually indicating time to a race start.

2. The sailboat racing instrument of claim 1 further comprising a battery formed in said bracket for recharging said smartphone.

3. The sailboat racing instrument of claim 2 further comprising a solar panel for charging said battery.

4. The sailboat racing instrument of claim 1 further comprising a solar panel for charging said smartphone.

5. The sailboat racing instrument of claim 4 wherein said solar panel is mounted on or forms a part of said bracket.

6. The sailboat racing instrument of claim 1 further comprising an antenna formed in said bracket for receiving a satellite position signal.

7. The sailboat racing instrument of claim 1 wherein said smartphone receives a race instruction from a race committee.

8. The sailboat racing instrument of claim 7 wherein the race instruction is visually indicated to a racing sailor on said lamp array.

9. The sailboat racing instrument of claim 8 wherein the race instruction is a race start time, and wherein a countdown to said race start is visually indicated to a racing sailor on said lamp array.

10. A racing instrument for a sailboat comprising:
a smartphone;
an app executing on the smartphone for displaying at least speed over ground of the sailboat as sensed by said smartphone;
a case for receiving said smartphone, said case having an integral mounting port;
a mounting fixture for removable connection to the mounting port for connecting said smartphone to the sailboat;
an array of lamps in data communication with said smartphone for visually indicating a race instruction.

11. The sailboat racing instrument of claim 10 further comprising a battery formed in the case for recharging said smartphone.

12. The sailboat racing instrument of claim 11 further comprising a solar panel for charging said battery.

13. The sailboat racing instrument of claim 1 further comprising an antenna formed in said case for receiving a satellite position signal.

14. The sailboat racing instrument of claim 1 wherein the race instruction is a race start time received via sms.

15. A race starting device for a sailboat, comprising:
an array of lamps;
a mounting fixture for removably attaching said array of lamps to the sailboat;
a battery for powering the array of lamps;
a receiver for receiving a signal indicative of a race instruction;
a processor for interpreting the race instruction signal; and
a driver circuit for separately powering each of the lamps in said array of lamps to visually represent the race instruction to the sailors.

16. The race starting device of claim 15 wherein said receiver receives the race instruction signal from a smartphone on the sailboat which is connected to said array of lamps.

17. The race starting device of claim 15 wherein said receiver receives the race instruction directly from the Race Committee.

18. The race starting device of claim 15 wherein said race instruction is transmitted to said receiver via SMS.

19. The race starting device of claim 15 wherein said race instruction is transmitted to said receiver via Bluetooth.

20. The race starting device of claim 15 wherein race instruction indicates a race start time.

21. The race starting device of claim 15 wherein said processor is a smartphone on the sailboat.

22. (canceled)
